(19) United States
(12) Patent Application Publication
(10) Pub. No.: US 2006/0274106 A1
(43) Pub. Date: Dec. 7, 2006

(54) Method of detecting missing or malfunctioning nozzle in inkjet printer

(75) Inventor: Seong-il Park, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/443,173

(22) Filed: May 31, 2006

(30) Foreign Application Priority Data
Jun. 1, 2005 (KR) 2005-46734

(51) Int. Cl. B41J 29/393

(52) U.S. Cl. 347/19

(57) ABSTRACT

A method of detecting a missing or malfunctioning nozzle in an inkjet printer whose scanning resolution is 1/N of a printing resolution thereof. The method includes printing a first test pattern by grouping nozzles according to the scanning resolution, detecting a group of nozzles producing a first test pattern having a light intensity value below a threshold light intensity by scanning the printed first test pattern, printing a second test pattern by grouping nozzles of the group producing the first test pattern and nozzles of groups adjacent to the group producing the first test pattern, detecting a group of nozzles producing a second test pattern having a light intensity value below the threshold light intensity by scanning the printed second test pattern, and determining a location of the missing or malfunctioning nozzle from the detection result.

### CROSS-REFERENCE TO RELATED APPLICATION

This application claims the benefit of Korean Patent Application No. 2005-46734, filed Jun. 1, 2005, in the Korean Intellectual Property Office, the disclosure of which is incorporated herein by reference.

### BACKGROUND OF THE INVENTION

1. Field of the Invention

An aspect of the present invention relates to an inkjet printer, and, more particularly, to a method of detecting a missing or malfunctioning nozzle in a line printing type inkjet printer, by which the missing or malfunctioning nozzle of the inkjet printer is detected by grouping nozzles to scan a printed test pattern if a scanning resolution is lower than a print resolution in the inkjet printer.

2. Description of the Related Art

In general, an inkjet printer, and, in particular, a color inkjet printer, employs a plurality of ink cartridges. A print head includes a plurality of nozzles formed in the bottom surface of each ink cartridge. The print head includes hundreds of nozzles. As such, some nozzles may not work, due to clogging, malfunctioning heaters or actuators, or errors in a power supply circuit. A missing or malfunctioning nozzle leaves a white space on a printing medium, resulting in low print quality. Thus, a method of detecting a missing or malfunctioning nozzle and a method of compensating for the missing or malfunctioning nozzle is required in a printer driver.

FIGS. 1A and 1B are illustrations of test patterns to detect a missing or malfunctioning nozzle according to the prior art. The test patterns are used for a method of detecting a missing or malfunctioning nozzle in a shuttle type inkjet printer in which a main scanning direction is perpendicular to a sub scanning direction. As shown in FIG. 1A, nozzles are divided into groups (T1 through T10), and then printing is performed for each group in an amount (10 lines) a scan system is able to detect. A missing or malfunctioning nozzle is detected by scanning each group and comparing the light intensity received by a photosensor with a threshold light intensity. In more detail, if it is determined that a missing or malfunctioning nozzle exists in a group, printing is performed for each nozzle in the amount (10 lines) the scan system is able to detect. For example, if the received light intensity of a group T5 is less that the threshold, printing is performed for nozzles (N21 through N30) of the group T5 using a line feeding method, as shown in FIG. 1B. The line feeding distance corresponds to a distance d2 between nozzles. A missing or malfunctioning nozzle is detected by scanning the printed test pattern using the scan system and comparing the light intensity received by the photosensor with the threshold light intensity. This way, the malfunctioning nozzle may be isolated and compensated for.

Recently, high-speed printing has been advanced by using an inkjet head that is as wide as the paper on which printing is done, instead of a narrow inkjet head which reciprocates across the paper. Inkjet printers working in this manner are called line printing (or page width) inkjet printers, and operate by moving the paper past a fixed inkjet head. Thus, the driving device of the inkjet printer is simple, and high-speed printing is possible.

The missing or malfunctioning nozzle detecting method described above may be used for shuttle type inkjet printers, which move their nozzles in a main scanning direction perpendicular to the printing medium delivery direction or sub scanning direction, but cannot be used for line printing type inkjet printers, in which the main scanning direction and the sub scanning direction are not separately classified.

### SUMMARY OF THE INVENTION

An aspect of the present invention provides a method of detecting a missing or malfunctioning nozzle in a line printing type inkjet printer, by which the missing or malfunctioning nozzle of the inkjet printer is detected when the scanning resolution is lower than the print resolution of the inkjet printer.

Another aspect of the present invention provides a line printing type inkjet printer, which detects a missing or malfunctioning nozzle when its scanning resolution is lower than its print resolution.

According to an aspect of the present invention, there is provided a method of detecting a missing or malfunctioning nozzle in an inkjet printer whose scanning resolution is 1/N of a printing resolution thereof, the method comprising printing a first test pattern by grouping nozzles according to the scanning resolution; detecting a group of nozzles producing a first test pattern having a light intensity value below a threshold light intensity by scanning the printed first test pattern, printing a second test pattern by grouping nozzles of the group producing the first test pattern and nozzles of groups adjacent to the group producing the first test pattern, detecting a group of nozzles producing a second test pattern having a light intensity value below the threshold light intensity by scanning the printed second test pattern, and determining a location of the missing or malfunctioning nozzle from the detection result.

In the printing of the second test pattern, if two or more groups having a value below the threshold are detected as the detection result in the detection of a group having a value below the threshold by scanning the first test pattern, each group may by printed with different colors.

Before the printing of the second test pattern, the method may further comprise: storing the number of the group having a value below the threshold and the numbers of the adjacent groups.

In the detection of a group having a value below the threshold by scanning the first test pattern, when the printed first test pattern is scanned, the scanning speed may be controlled.

If N is 2, in the printing of the first test pattern, the first test pattern may be printed by grouping the nozzles in a two by two formation, and in the printing of the second test pattern, the second test pattern may be printed by grouping each of nozzles of the group having a value below the threshold and a nozzle of an adjacent previous group and a nozzle of an adjacent subsequent group.

If N is 3, in the printing of the first test pattern, the first test pattern may be printed by grouping the nozzles in a three by three formation, and in the printing of the second test pattern, the second test pattern may be printed by grouping each of nozzles of the group having a value below the threshold with nozzles of an adjacent previous group and nozzles of an adjacent subsequent group. In the printing of the second test pattern, printing may be performed for a new group including the center nozzle of the group having a value below the threshold with a different color.

In the printing of the first test pattern and the printing of the second test pattern, after printing is performed for one group, printing is performed for the subsequent group after moving the printing medium a predetermined distance.

According to another aspect of the present invention, there is provided an inkjet printer whose scanning resolution is 1/N of a printing resolution thereof, the inkjet printer comprising a printing module which prints a first test pattern by grouping nozzles according to the scanning resolution, a scanning module which detects a group of nozzles producing the first test pattern having a light intensity value below a threshold light intensity by scanning the printed first test pattern, and a controller which forms a second test pattern by grouping nozzles of the group producing the first test pattern and nozzles of groups adjacent to the group producing the first test pattern, wherein the printing module prints the second test pattern formed by the controller, the scanning module detects a group producing the second test pattern having a light intensity value below the threshold light intensity by scanning the printed second test pattern, and the controller detects a missing or malfunctioning nozzle based on the result detected by the scanning module.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B are illustrations of test patterns for detecting a missing or malfunctioning nozzle according to the prior art;

FIG. 2 is a block diagram of an inkjet printer to which the present invention is applied;

FIG. 3 is a flowchart illustrating a method of detecting a missing or malfunctioning nozzle in an inkjet printer according to an embodiment of the present invention;

FIG. 4 is a flowchart illustrating a method of detecting a missing nozzle when a scanning resolution is ½ of a printing resolution, according to an embodiment of the present invention;

FIGS. 5A through 5D illustrate test patterns according to the embodiment of FIG. 4;

FIG. 6 is a flowchart illustrating a method of detecting a missing or malfunctioning nozzle when a scanning resolution is ⅓ of a printing resolution, according to an embodiment of the present invention; and

FIGS. 7A through 7D illustrate test patterns according to the embodiment of FIG. 6.

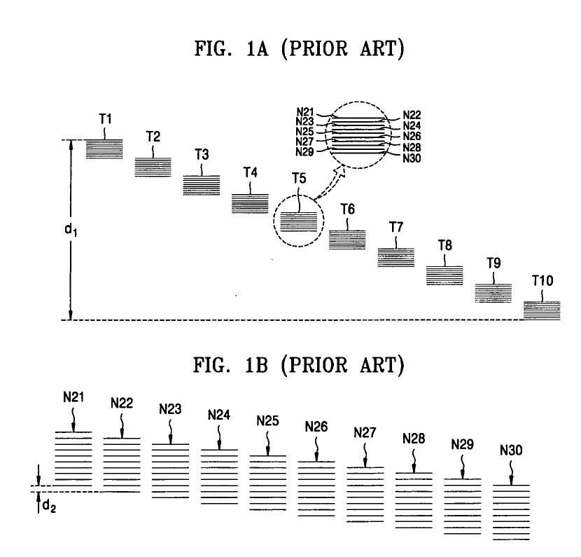

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

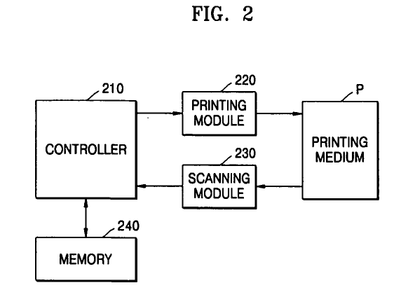

FIG. 2 is a block diagram of an inkjet printer to which the present invention is applied. As shown in FIG. 2, the inkjet printer includes a controller 210, a printing module 220, a scanning module 230, and a memory 240. The controller 210 controls the general operation of the inkjet printer, and, in particular, detects missing or malfunctioning nozzles based on a signal output from the scanning module 230. The controller 210 controls a scanning speed and a detecting speed of the scanning module 230.

Here, it is noted that the term “missing nozzle” is to be understood as referring to a missing nozzle or a malfunctioning nozzle in the specification and the claims hereinbelow.

The controller 210 controls the printing module 220 to print a test pattern on a printing medium P (i.e., paper, transparency, etc.). The printing module 220 includes a nozzle module (not shown) having a plurality of nozzle arrays which eject ink therethrough. According to an embodiment of the invention, the nozzle module is as wide as or wider than the printing medium P. That is, the line printing type inkjet printer to which the present invention is applied prints an image by ejecting ink from the nozzle module having a length that corresponds to a width of the printing medium P.

The scanning module 230 detects a group of nozzles including a missing or malfunctioning nozzle using a sensing device, such as a photosensor (not shown), by scanning the test pattern printed on the printing medium P by a group of nozzles. The photosensor includes a light emitting sensor (e.g. a light emitting diode) to radiate light and a light receiving sensor to receive light reflected from the printing medium P. A signal output from the light receiving sensor is input to the controller 210, and then the controller 210 detects whether a nozzle is missing. The light emitting sensor and the light receiving sensor may be constructed in the same body or in separate structures.

In an embodiment of the present invention, the inverse of the light intensity received by the photosensor of the scanning module 230 is compared with a threshold light intensity, and a group of nozzles producing a test pattern of which the inverse of the received light intensity is below the threshold is assumed to include a missing or malfunctioning nozzle. The memory 240 stores the number of such a group of nozzles, and the previous and subsequent groups, based on a signal output from the scanning module 230.

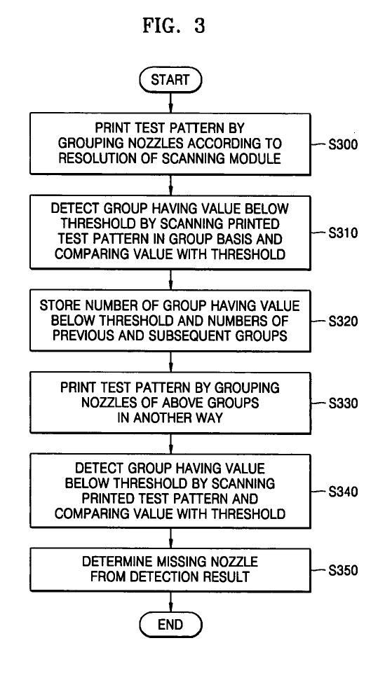

FIG. 3 is a flowchart illustrating a method of detecting a missing or malfunctioning nozzle in an inkjet printer when a scanning resolution is 1/N of a printing resolution, according to an embodiment of the present invention. The method will be described by linking to the components of FIG. 2. As shown in FIGS. 2 and 3, in operation op 300, the printing module 220 prints a test pattern by grouping nozzles in an N by N formation. The printing module 220 sequentially prints each group of the test pattern on the printing medium P. Here, after one group is printed, the subsequent group may be printed after moving the printing medium P by a predetermined distance.

In operation op 310, the scanning module 230 detects a group of nozzles producing a test pattern having a light intensity value below the threshold light intensity by scanning the test pattern based on the group of nozzles producing it and comparing the value with the threshold light intensity. Here, the controller 210 controls the scanning speed and the detecting speed of the scanning module 230.

In operation op 320, the controller 210 stores the number of the detected group whose test pattern has a value of a light intensity that is below the threshold light intensity, and numbers of the previous and subsequent groups, which are groups of nozzles that are adjacent to the detected group, in the memory 240.

In operation op 330, the printing module 220 prints a test pattern by grouping nozzles in another manner. The printing module 220 sequentially prints the test pattern on the printing medium P. Here, after one group is printed, the subsequent group may be printed after moving the printing medium P a predetermined distance. If an adjacent group has a value below the threshold too, printing may be performed for the adjacent group with a different color.

In operation op 340, the scanning module 230 detects a group of nozzles whose test pattern has a light intensity value below the threshold light intensity by scanning the test pattern based on the group of nozzles producing it and comparing the value with the threshold light intensity.

In operation op 350, the controller 210 determines a missing or malfunctioning nozzle from the detection result.

The missing or malfunctioning nozzle detection method will be described in detail by illustrating a case where N is 2 and a case where N is 3.

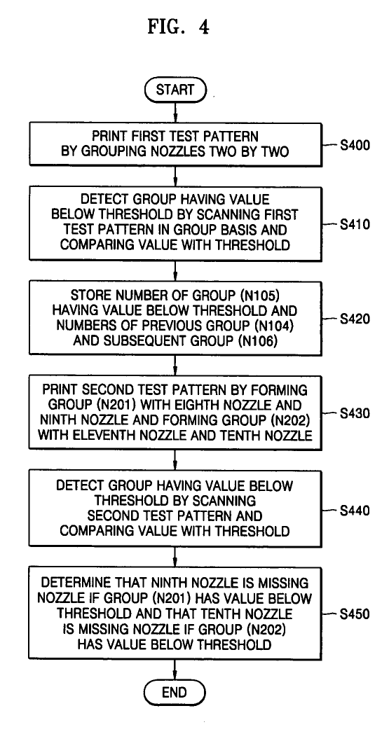

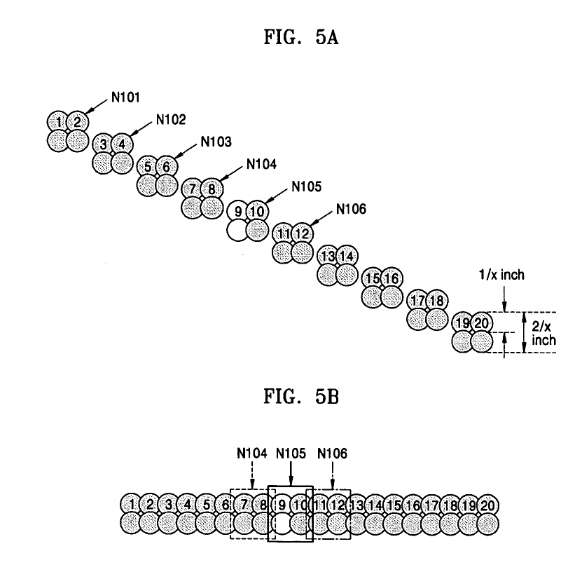

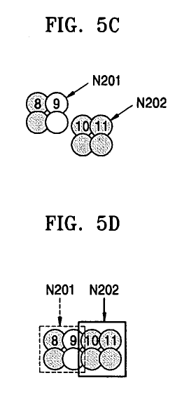

FIG. 4 is a flowchart illustrating a method of detecting a missing or malfunctioning nozzle when the scanning resolution is ½ of the printing resolution, i.e., when N is 2, according to an embodiment of the present invention. The method will be described by linking to the components of FIG. 2. For example, the scanning resolution is 300 dpi (dots per inch) when the printing resolution is 600 dpi. FIGS. 5A through 5D illustrate test patterns according to the embodiment of FIG. 4.

Referring to FIGS. 2, 4 and 5A through 5D, in operation op 400, the printing module 220 prints a first test pattern by grouping nozzles two by two. FIGS. 5A and 5B illustrate the first test pattern. As shown in FIG. 5A, the printing module 220 sequentially prints each group of the first test pattern on the printing medium P by grouping nozzles in a two by two (N101, N102, . . . ) formation. Here, after one group of nozzles is printed, the subsequent group may be printed after moving the printing medium P by a predetermined distance.

In operation op 410, the scanning module 230 detects a group of nozzles whose test pattern has a light intensity value below the threshold light intensity by scanning the first test pattern of the group of nozzles producing the test pattern and comparing the light intensity value with the threshold light intensity. In FIGS. 5A and 5B, a group N105 has a value below the threshold.

In operation op 420, the controller 210 stores the number of the detected group of nozzles N105 having a value below the threshold, and the numbers of the previous group N104 and the subsequent group N106, in the memory 240.

In operation op 430, the controller 210 forms a group of nozzles N201 by grouping an eighth nozzle and a ninth nozzle, and a group of nozzles N202 by grouping a tenth nozzle and an eleventh nozzle, and then the printing module 220 prints a second test pattern. If an adjacent group of nozzles has a light intensity value below the threshold light intensity too, printing may be performed for the adjacent group with a different color. FIGS. 5C and 5D illustrate the second test pattern.

In operation op 440, the scanning module 230 detects a group of nozzles whose test pattern has a light intensity value below the threshold light intensity by scanning the second test pattern of the group and comparing the light intensity value with the threshold light intensity.

In operation op 450, the controller 210 determines that the ninth nozzle is a missing or malfunctioning nozzle if the group of nozzles N201 has a light intensity value below the threshold light intensity, and that the tenth nozzle is a missing or malfunctioning nozzle if the group of nozzles N202 has a light intensity value below the threshold light intensity.

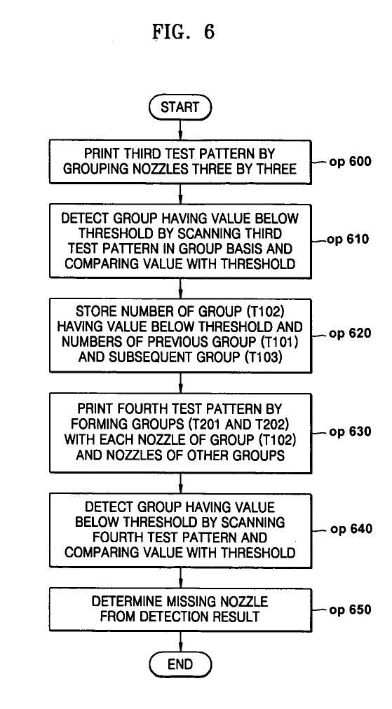

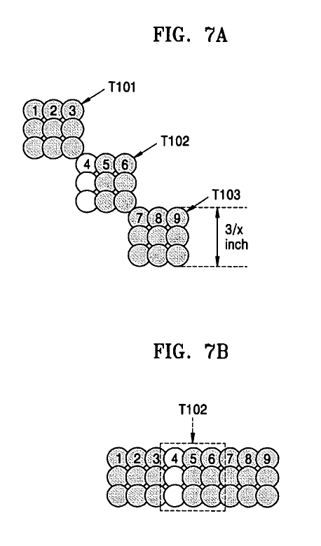

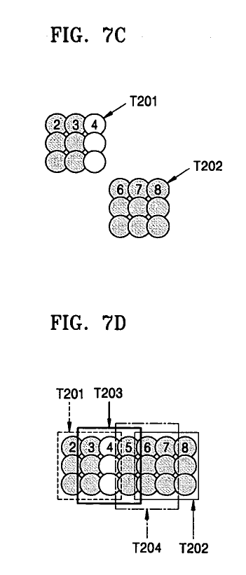

FIG. 6 is a flowchart illustrating a method of detecting a missing or malfunctioning nozzle of a line printing type inkjet printer, in which the main scanning direction and the sub scanning direction are not separately classified, when the scanning resolution is ⅓ of the printing resolution, according to an embodiment of the present invention. The method will be described by linking to the components of FIG. 2. For example, the scanning resolution is 200 dpi when the printing resolution is 600 dpi. FIGS. 7A through 7D illustrate test patterns according to the embodiment of FIG. 6.

As shown in FIGS. 2, 6 and 7, in operation op 600, the printing module 220 prints a third test pattern by grouping nozzles in a three by three formation. FIGS. 7A and 7B illustrate the third test pattern. As shown in FIG. 7A, the printing module 220 sequentially prints each group of the third test pattern on the printing medium P by grouping nozzles in a three by three (T101, T102, . . . ) formation. Here, after one group of nozzles is printed, the subsequent group of nozzles may be printed after moving the printing medium P by a predetermined distance.

In operation op 610, the scanning module 230 detects a group of nozzles whose test pattern has a light intensity value below the threshold light intensity by scanning the third test pattern of the group and comparing the light intensity value with the threshold light intensity.

In operation op 620, the controller 210 stores the number of the detected group of nozzles T102 having a light intensity value below the threshold light intensity, and the numbers of the previous group of nozzles T101 and the subsequent group of nozzles T103, in the memory 240. In FIGS. 7A and 7B, a group of nozzles T102 has a light intensity value below the threshold light intensity.

In operation op 630, the controller 210 forms groups of nozzles T201 and T202 by grouping each nozzle of the group T102 and corresponding nozzles of the other groups, and then the printing module 220 prints a fourth test pattern. If an adjacent group produces a test pattern that has a light intensity value below the threshold light intensity too, printing may be performed for the adjacent group with a different color. FIGS. 7C and 7D illustrate the fourth test pattern. A fourth nozzle forms the group T201 with second and third nozzles, and a sixth nozzle forms the group T202 with seventh and eighth nozzles. A fifth nozzle forms a group T203 with the third and fourth nozzles or a group T204 with the sixth and seventh nozzles. Here, printing may be performed for the group (T203 or T204) including the fifth nozzle with a different color.

In operation op 640, the scanning module 230 detects a group of nozzles whose test pattern has a light intensity value below the threshold light intensity by scanning the fourth test pattern of the group and comparing the light intensity value with the threshold light intensity.

In operation op 650, the controller 210 determines a missing or malfunctioning nozzle from the detection result. As a result of the detection, if the group of nozzles T201 has a value below the threshold, the controller 210 determines that the fourth nozzle is a missing or malfunctioning nozzle, and if the group of nozzles T202 has a value below the threshold, the controller 210 determines that the sixth nozzle is a missing or malfunctioning nozzle. If the groups of nozzles T203 and T204 have values below the threshold, the controller 210 determines that the fifth nozzle is a missing or malfunctioning nozzle.

As is described above, according to aspects of the present invention, if the scanning resolution is lower than the printing resolution in a line printing type inkjet printer, in which the main scanning direction and the sub scanning direction are not separately classified, a missing or malfunctioning nozzle may be detected. In addition, since the resolving power may be improved and a missing or malfunctioning nozzle may be accurately detected using an existing photosensor instead of a high resolution photosensor, manufacturing costs may be reduced and printing quality may be improved.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of detecting a missing or malfunctioning nozzle in an inkjet printer whose scanning resolution is 1/N of a printing resolution thereof, the method comprising:
printing a first test pattern by grouping nozzles according to the scanning resolution;
detecting a group of nozzles producing the first test pattern having a light intensity value below a threshold light intensity by scanning the printed first test pattern;
printing a second test pattern by grouping nozzles of the group producing the first test pattern and nozzles of groups adjacent to the group producing the first test pattern;
detecting a group of nozzles producing a second test pattern having a light intensity value below the threshold light intensity by scanning the printed second test pattern; and
determining a location of the missing or malfunctioning nozzle from the detection result.

2. The method of claim 1, wherein, in the printing of the second test pattern, if two or more groups of nozzles produce a test pattern having a light intensity value below the threshold light intensity are detected in the first detecting operation, each group of nozzles is printed with different colors.

3. The method of claim 1, further comprising storing the number of the group producing the first test pattern and the numbers of the adjacent groups of nozzles before the printing of the second test pattern.

4. The method of claim 1, wherein, in the first detecting operation, when the printed first test pattern is scanned, a scanning speed is monitored and controlled based on the monitoring.

5. The method of claim 1, wherein, if N is 2, in the printing of the first test pattern, the first test pattern is printed by grouping the nozzles in a two by two formation, and, in the printing of the second test pattern, the second test pattern is printed by grouping each of the nozzles of the group producing the test pattern having a light intensity value below the threshold light intensity and a nozzle of an adjacent previous group of nozzles and a nozzle of an adjacent subsequent group of nozzles.

6. The method of claim 1, wherein if N is 3, in the printing of the first test pattern, the first test pattern is printed by grouping the nozzles in a three by three formation, and, in the printing of the second test pattern, the second test pattern is printed by grouping each of the nozzles of the group producing the test pattern having a light intensity value below the threshold light intensity with nozzles of an adjacent previous group and nozzles of an adjacent subsequent group.

7. The method of claim 6, wherein, in the printing of the second test pattern, printing is performed for a new group of nozzles, including the center nozzle of the group producing the second test pattern, with a different color.

8. The method of claim 1, wherein, in the printing of the first test pattern and the printing of the second test pattern, after printing is performed for one group of nozzles, printing is performed for a subsequent group of nozzles after moving a printing medium on which the test patterns are printed by a predetermined distance.

9. An inkjet printer whose scanning resolution is 1/N of a printing resolution thereof, the inkjet printer comprising:
a printing module which prints a first test pattern by grouping nozzles according to the scanning resolution;
a scanning module which detects a group of nozzles producing the first test pattern having a light intensity value below a threshold light intensity by scanning the printed first test pattern; and
a controller which forms a second test pattern by grouping nozzles of the group producing the first test pattern and nozzles of groups adjacent to the group producing the first test pattern,
wherein the printing module prints the second test pattern formed by the controller, the scanning module detects a group producing the second test pattern having a light intensity value below the threshold light intensity by scanning the printed second test pattern, and the controller detects a missing or malfunctioning nozzle based on the result detected by the scanning module.

10. The inkjet printer of claim 9, wherein, if two or more groups producing a test pattern having a light intensity value below the threshold light intensity are detected by the scanning module when the first test pattern is scanned, the printing module prints each group of nozzles with different colors.

11. The inkjet printer of claim 9, further comprising a memory which stores the number of the group of nozzles having a value below the threshold as a result detected by the scanning module, the number of the previous group of nozzles, and the number of the subsequent group of nozzles.

12. The inkjet printer of claim 9, wherein the controller controls the scanning speed of the scanning module.

13. The inkjet printer of claim 9, wherein, if N is 2, the printing module prints the first test pattern by grouping the nozzles in a two by two formation and prints the second test pattern by grouping each of nozzles of the group producing the first test pattern having a light intensity value below the threshold light intensity and a nozzle of an adjacent previous group of nozzles and a nozzle of an adjacent subsequent group of nozzles.

14. The inkjet printer of claim 9, wherein, if N is 3, the printing module prints the first test pattern by grouping the nozzles in a three by three formation and prints the second test pattern by grouping each of nozzles of the group producing the second test pattern having a light intensity value below the threshold light intensity with nozzles of an adjacent previous group of nozzles and nozzles of an adjacent subsequent group of nozzles.

15. The inkjet printer of claim 14, wherein the printing module performs printing for a new group of nozzles, including the center nozzle of the group producing the test pattern having a light intensity value below the threshold light intensity, with a different color.

16. The inkjet printer of claim 9, wherein the printing module performs printing for a subsequent group of nozzles after moving a printing medium on which the test patterns are printed by a predetermined distance after printing is performed for one group of nozzles.
